(19) United States
(12) Patent Application Publication
(10) Pub. No.: US 2006/0290166 A1
(43) Pub. Date: Dec. 28, 2006

(54) DOOR STRUCTURE FOR A MOTOR VEHICLE

(75) Inventors: Ludger Gehringhoff, Paderborn (DE); Johannes Schafers, Borchen (DE)

Correspondence Address: HENRY M FEIEREISEN, LLC, 350 FIFTH AVENUE, SUITE 4714, NEW YORK, NY, 10118, US

(73) Assignee: Benteler Automobiltechnik GmbH, Paderborn (DE)

(21) Appl. No.: 11/426,446

(22) Filed: Jun. 26, 2006

(30) Foreign Application Priority Data
Jun. 28, 2005 (DE) 10 2005 030 507.5

(51) Int. Cl. B60J 5/00

(52) U.S. Cl. 296/146.6

(57) ABSTRACT

A door structure of a motor vehicle includes an inside door panel, and a single-piece reinforcement element which is disposed below a window parapet of the door structure and non-detachably secured to the inside door panel at a side distal to an outside door panel. The reinforcement element includes a wraparound frame having a top frame side extending along the window parapet, a bottom frame side extending along a lower edge of the door structure, a front frame side disposed in a hinge area between the top frame side and the bottom frame side, and a rear frame side disposed in a lock area between the top frame side and the bottom frame side, thereby defining an opening. Disposed in the opening and formed in one piece with the frame is an embossed door impact beam which extends from the front frame side to the rear frame side. The reinforcement element is made of high-strength hot formable steel defined by a tensile strength ranging from 1400 N/mm² to 1600 N/mm².

### CROSS-REFERENCES TO RELATED APPLICATIONS

This application claims the priority of German Patent Application, Serial No. 10 2005 030 507.5, filed Jun. 28, 2005, pursuant to 35 U.S.C. 119(a)-(d), the content of which is incorporated herein by reference.

### BACKGROUND OF THE INVENTION

The present invention relates to a door structure of a motor vehicle.

Nothing in the following discussion of the state of the art is to be construed as an admission of prior art.

A door structure of a motor vehicle, in particular of a passenger car, is disclosed in German Offenlegungsschrift DE 100 01 753, which describes a module carrier having a metal panel disposed between an inside door panel and an outside door panel. The metal panel is provided with a side impact carrier and includes various mechanical and electrical operating and control modules, such as, e.g., the window lifting mechanism. Such a module carrier is very complicated in structure in view of the numerous functions that need to be executed and has to balance the construction and course of the side impact carrier against the operativeness of the mechanical and electrical operating and control modules.

German Offenlegungsschrift DE 2 023 067 A discloses a door structure having an inside door panel provided with a number of reinforcements on a side distal to the outside door panel. This door structure is difficult to assemble as a result of the multiplicity of single parts.

It would therefore be desirable and advantageous to provide an improved door structure which obviates prior art shortcomings and which is easy and quickly to install and affords improved force introduction from a door impact beam.

### SUMMARY OF THE INVENTION

According to one aspect of the present invention, a door structure of a motor vehicle includes an inside door panel, a single-piece reinforcement element disposed below a window parapet of the door structure and non-detachably secured to the inside door panel at a side distal to an outside door panel, with the reinforcement element including a wraparound frame having a top frame side extending along the window parapet, a bottom frame side extending along a lower edge of the door structure, a front frame side disposed in a hinge area between the top frame side and the bottom frame side, and a rear frame side disposed in a lock area between the top frame side and the bottom frame side, thereby defining an opening, and an embossed door impact beam disposed in the opening and formed in one piece with the frame, with the door impact beam extending from the front frame side to the rear frame side, wherein the reinforcement element is made of high-strength hot formable steel defined by a tensile strength ranging from 1400 N/mm² to 1600 N/mm².

According to another feature of the present invention, the steel may be hot formable steel defined by a tensile strength of 1500 N/mm².

By using high-strength hot formable steel, complex door structures can be manufactured at high precision. Integration of the door impact beam in the door structure can be implemented in particular, when hot-formed steels are used because significantly improved strength and thus superior crash behavior can be attained while providing a lightweight structure at the same time.

The application of integrated door structures has not been commercially viable up to now as many problems were encountered during production. The present invention overcomes these problems by using steel of high strength to produce superior products and to provide optimal manufacturing conditions. In particular when greater components such as a door structure with integrated side impact protection for a motor vehicle are involved, the stringent demands relating to the used material and the manufacturing process are satisfied to produce a structure that is responsive in an optimum manner in the event of a crash.

According to another aspect of the present invention, high-strength cold formable steel may also be used, having a tensile strength ranging from 900 N/mm² to 1100 N/mm². Currently preferred is cold formable steel having a tensile strength of 1000 N/mm².

A reinforcement element according to the present invention resolves prior art problems by uniting several important components into a single unitary structure, thus eliminating a need for a separate lock reinforcement, hinge reinforcement, or window channel reinforcement for example. In particular, the need for a separate door impact beam is eliminated. As a consequence, the number of components is reduced and the assembly is made easier, ultimately also saving costs. The reinforcement element improves the crash behavior of the motor vehicle and the door structure because the single-piece frame construction improves introduction of impact forces into the vehicle body. It will be understood by a person skilled in the art that a reinforcement element according to the invention cannot be confused with a module carrier which accommodates electric or mechanical components. Rather, the reinforcement element of the invention represents a distinct structure that may, optionally, be mounted to such a module carrier, whereby some functions of the module carrier, in particular the integration of a door impact beams, can then be assumed by the frame-like reinforcement element according to the present invention.

According to another feature of the present invention, the door impact beam may extend diagonally between the front frame side and the rear frame side.

According to another feature of the present invention, at least one stiffening strut may be disposed in the opening and connected to the door impact beam. Suitably, the stiffening strut may extend from a corner area of the frame to the door impact beam. Of course, several stiffening struts may be provided as well. For example, the diagonally extending door impact beam may be connected to two stiffening struts, of which one stiffening strut extends from one corner area and the other stiffening strut extends from another corner area to establish a cross-like reinforcement of the opening. The opening is thus subdivided by the door impact beam and the stiffening struts into several regions. A crossing reinforcement provides significantly better crash properties because the entire door structure becomes more rigid and thus has high energy absorption capability. Suitably, the one stiffening strut is connected to a forward portion of the door impact beam, whereas the other stiffening strut is connected to a rearward portion of the door impact beam.

According to another feature of the present invention, the reinforcement element may have a profiled configuration to realize a high bending stiffness. Suitably, the wraparound frame is profiled. For example, it is possible to alter the geometry by using metal sheets, e.g. steel sheets, with zones of reduced sheet thickness. The zones of reduced sheet thickness may be spaced horizontally from one another or also vertically from one another. Positioning and size of the zones are dependent on the stress situation to be expected.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is an exploded illustration of a configuration of a prior art door structure of a passenger car;

FIG. 2 is a plan view of one embodiment of a reinforcement element according to the present invention for use in a door structure of a motor vehicle;

FIG. 3 is a sectional view of the reinforcement element, taken along the line III-III in FIG. 2;

FIG. 4 is a sectional view of the reinforcement element, taken along the line IV-IV in FIG. 2;

FIG. 5 is a plan view of a variation of the reinforcement element of FIG. 2;

FIG. 6 is a plan view of another variation of the reinforcement element of FIG. 2;

FIG. 7 is a plan view of yet another variation of the reinforcement element of FIG. 2; and

FIG. 8 is a plan view of still another variation of the reinforcement element of FIG. 2.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

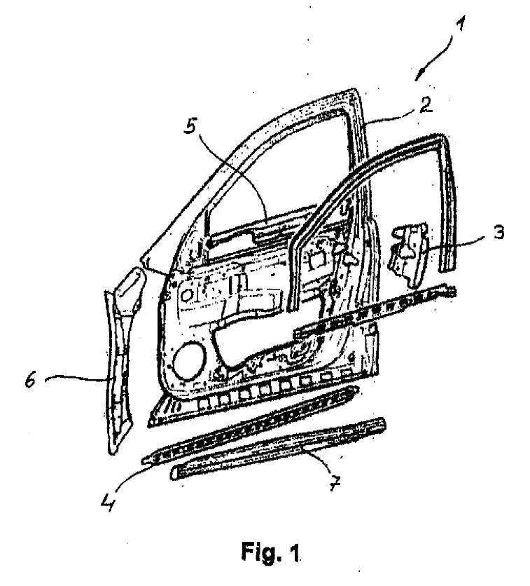

Turning now to the drawing, and in particular to FIG. 1, there is shown an exploded illustration of a configuration of a prior art door structure, generally designated by reference numeral 1, for use in a motor vehicle, such as a passenger car. The conventional door structure 1 includes many single parts, including an inside door panel 2 which requires further reinforcement in certain areas to withstand loads to which the door is exposed. Provided is a lock reinforcement 3, a first well reinforcement 4, a second well reinforcement 5, a hinge reinforcement 6 as well as a door impact reinforcement 7. All these components must be mounted individually to assemble the door structure 1. Assembly requires the individual components to have respective joining surfaces, thereby adversely affecting the overall weight of the motor vehicle.

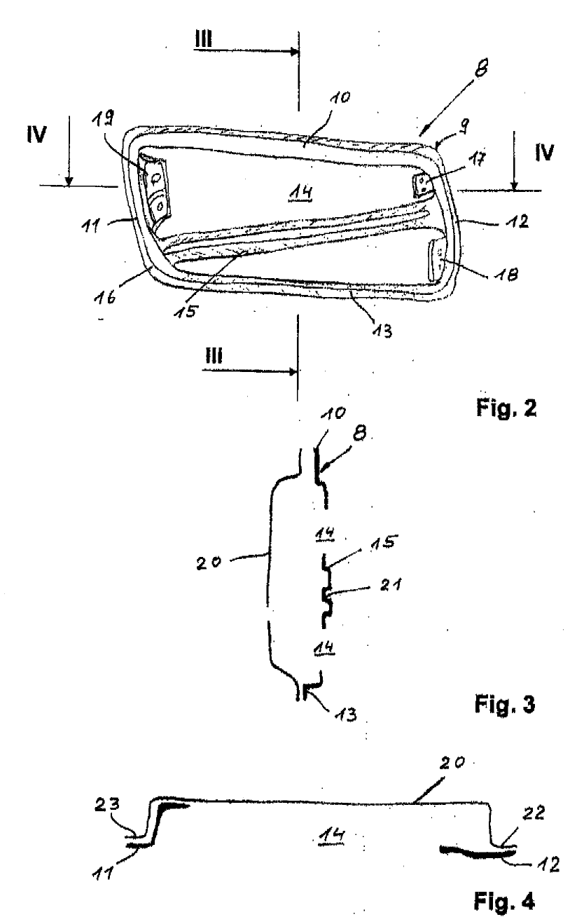

Referring now to FIG. 2, there is shown a plan view of one embodiment of a reinforcement element according to the present invention, generally designated by reference numeral 8 for integration in a door structure. The reinforcement element 8 forms hereby with the inside door panel 2 and an unillustrated outside door panel the actual door structure, whereby the reinforcement element 8 and the inside and outside door panels are joined together by a connection process such as spot welding. The reinforcement element 8 is made of one piece from a metal sheet, e.g. steel sheet, and shaped using a hot forming process. High-strength steel of a tensile strength ranging from 1400 N/mm² to 1600 N/mm² is used as material. Currently preferred is hot formable steel having a tensile strength of 1500 N/mm².

Although the application of hot forming is currently preferred, the steel sheet may also be shaped using a cold forming process. High-strength steel of a tensile strength ranging from 900 N/mm² to 1100 N/mm² is hereby used as material. Currently preferred is a cold formable steel having a tensile strength of 1000 N/mm².

Optionally, the reinforcement element 8 may be provided with a surface coating, in particular galvanized, for protection against corrosion.

The reinforcement element 8 is shaped in the form of a wraparound frame 9 having a top frame side 10 which extends along a window parapet (not shown), a bottom frame side 13 which extends along a lower edge of the door structure, a front frame side 11 which is disposed in a hinge area between the top and bottom frame sides 10, 13, and a rear frame side 12 which is disposed in a lock area between the top and bottom frame sides 10, 13. As the lower edge of the door structure extends in substantial parallel relationship to the window parapet, the top and bottom frame sides 10, 13 also extend in substantial parallel relationship. The front and rear frame sides 11, 12 extend at a small angle in relation to the top and bottom frame sides 10, 13. The reason is the respective geometry of the door structure. The frame 9 has thus a substantial parallelogram-shaped configuration and defines an opening (window) 14 in which a door impact beam 15 is disposed and connected in one piece with the frame 9.

The door impact beam 15 extends from the front frame side 11 to the rear frame side 12 and is inclined in relation to the bottom frame side 13 so as to extend diagonally between the front and rear frame sides 11, 12. The door impact beam 15 extends here from a corner area 16 between the front frame side 11 and the bottom frame side 13 to the upper region of the rear frame side 12. In this way, it is possible to provide mounting plates 17, 18 within the opening 14 on the rear frame side 12 above and below the door impact beam 15 to allow securement of the reinforcement element 8 to the inside door panel 20 (FIG. 3). A further mounting plate 19 is provided on the front frame side 11 within the opening 14.

FIG. 3 is a sectional view of the reinforcement element 8, taken along the line III-III in FIG. 2, to illustrate the securement of the reinforcement element 8 to an edge of the inside door panel 20. Both the reinforcement element 8 and the door impact beam 15 are profiled. The profile confers increased bending stiffness to the reinforcement element 8. The door impact beam 15 is formed in midsection with a groove-shaped boss 21 which extends over the entire length of the door impact beam 15. The top and bottom frame sides 10, 13 of the reinforcement element 8 conform substantially to the contour of the inside door panel 20. As shown by way of example in FIG. 3, the bottom frame side 13 is angled to a greater degree than the top frame side 10.

Turning now to FIG. 4, there is shown a sectional view of the reinforcement element, taken along the line IV-IV in FIG. 2. The rear frame side 12 of the reinforcement element 8 extends in substantial parallel relationship to the inside door panel 20, whereas the front frame side 11 of the reinforcement element 8 has a S-shaped cross section to conform to the contour of the door inside panel 20. In the illustrated cross section view, the inside door panel 20 has a quasi cup-shaped configuration with terminal flanges 22, 23 in parallel relationship to the front frame side 11 and the rear frame side 12, respectively.

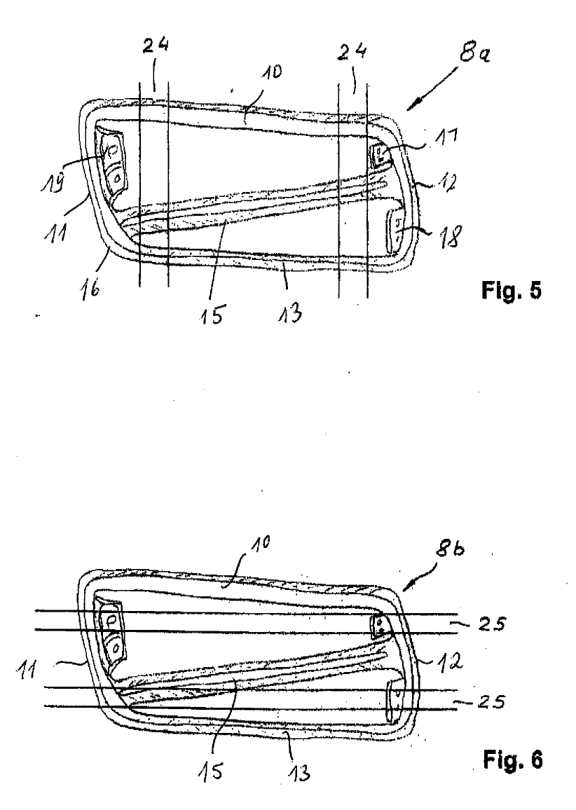

FIG. 5 is a plan view of a variation of the reinforcement element of FIG. 2, generally designated by reference numeral 8a. Parts corresponding with those in FIG. 2 are generally denoted by identical reference numerals and not explained again. The description below will center on the differences between the embodiments. In this embodiment, the reinforcement element 8a has zones 24 of different sheet thickness which are spaced horizontally from one another. In FIG. 6, which is a plan view of another variation of the reinforcement element of FIG. 2, generally designated by reference numeral 8b, the reinforcement element 8b has zones 25 of different sheet thickness which are spaced vertically from one another. In both variations, the reduced sheet thickness may be realized through partial rolling of a sheet metal blank to provide the material distribution as desired.

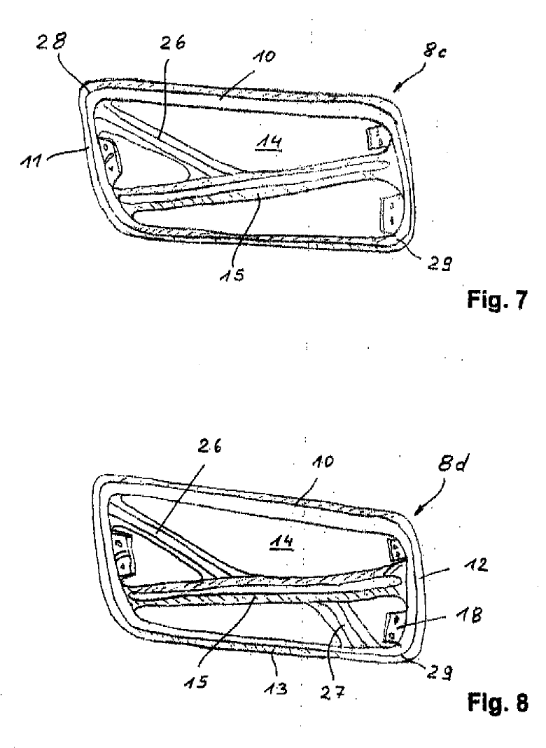

FIG. 7 is a plan view of yet another variation of the reinforcement element of FIG. 2, generally designated by reference numeral 8c. Again parts corresponding with those in FIG. 2 are generally denoted by identical reference numerals and not explained again. The description below will center on the differences between the embodiments. In this embodiment, the reinforcement element 8c is provided with an additional stiffening strut 26 which is embossed in longitudinal direction in like manner as the door impact beam 15. The stiffening strut 26 extends from an upper corner area 28 between the top frame side 10 and the front frame side 11 diagonally in the direction of the opposite corner area 29 between the rear frame side 12 and the bottom frame side 13. The stiffening strut 26 reaches however only to the door impact beam 15. The presence of the stiffening strut 26 subdivides the opening14 into three triangular regions. The region above the door impact beam 15 is hereby divided by the stiffening strut 26. The provision of the stiffening strut 26 confers better force introduction from the door impact beam 15 into the reinforcement element 8c and its frame 9 and thus into the door structure of the motor vehicle.

FIG. 8 shows still another variation of the reinforcement element of FIG. 2, generally designated by reference numeral 8d. In this embodiment, the reinforcement element 8d has a further stiffening strut 27 which is also embossed in longitudinal direction and extends from an lower corner area 29 between the rear frame side 12 and the bottom frame side 13 to the door impact beam 15. As the mounting plate 18 is disposed in the corner area 29, the stiffening strut 27 is moved slightly inwards away from the corner area 29 in the direction of the bottom frame side 13 so that the longitudinal axis of the stiffening strut 27 intersects the top frame side 10 approximately in midsection. In this variation, the opening 14 is subdivided into four distinct regions by the stiffening struts 26, 27 and the door impact beam 15. In comparison with the variation of FIG. 7, the reinforcement element 8d is even more rigid. The force introduction into the door structure and motor vehicle is thus further enhanced.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A door structure of a motor vehicle, comprising:
an inside door panel;
a single-piece reinforcement element disposed below a window parapet of the door structure and non-detachably secured to the inside door panel at a side distal to an outside door panel, said reinforcement element including a wraparound frame having a top frame side extending along the window parapet, a bottom frame side extending along a lower edge of the door structure, a front frame side disposed in a hinge area between the top frame side and the bottom frame side, and a rear frame side disposed in a lock area between the top frame side and the bottom frame side, thereby defining an opening; and
an embossed door impact beam disposed in the opening and formed in one piece with the frame, said door impact beam extending from the front frame side to the rear frame side,
wherein the reinforcement element is made of high-strength hot formable steel defined by a tensile strength ranging from 1400 N/mm² to 1600 N/mm².

2. The door structure of claim 2, wherein the steel has a tensile strength of 1500 N/mm².

3. The door structure of claim 1, wherein the door impact beam extends diagonally between the front frame side and the rear frame side.

4. The door structure of claim 1, further comprising at least one stiffening strut disposed in the opening and connected to the door impact beam.

5. The door structure of claim 4, wherein the at least one stiffening strut extends from a corner area of the frame to the door impact beam.

6. The door structure of claim 1, further comprising a first stiffening strut disposed in the opening and connected to a forward portion of the door impact beam, and a second stiffening strut disposed in the opening and connected to a rearward portion of the door impact beam.

7. The door structure of claim 1, further comprising a first stiffening strut disposed in the opening and extending from one corner area of the frame and a second stiffening strut disposed in the opening and extending from another corner area to provide a cross-like configuration.

8. The door structure of claim 1, wherein the reinforcement element has a profiled configuration.

9. The door structure of claim 8, wherein the frame of the reinforcement element is profiled.

10. The door structure of claim 1, wherein the reinforcement element has zones of reduced sheet thickness realized by a rolling process.

11. The door structure of claim 10, wherein the zones of reduced sheet thickness are spaced horizontally from one another.

12. The door structure of claim 10, wherein the zones of reduced sheet thickness are spaced vertically from one another.

13. The door structure of claim 1, wherein the front and rear frame sides extend at a small angle in relation to the top and bottom frame sides.

14. A door structure of a motor vehicle, comprising:
an inside door panel;
a single-piece reinforcement element disposed below a window parapet of the door structure and non-detachably secured to the inside door panel at a side distal to an outside door panel, said reinforcement element including a wraparound frame having a top frame side extending along the window parapet, a bottom frame side extending along a lower edge of the door structure, a front frame side disposed in a hinge area between the top frame side and the bottom frame side, and a rear frame side disposed in a lock area between the top frame side and the bottom frame side, thereby defining an opening; and
an embossed door impact beam disposed in the opening and formed in one piece with the frame, said door impact beam extending from the front frame side to the rear frame side,
wherein the reinforcement element is made of high-strength cold formable steel defined by a tensile strength ranging from 900 N/mm² to 1100 N/mm².

15. The door structure of claim 14, wherein the steel has a tensile strength of 1000 N/mm².
